(19) United States
(12) Patent Application Publication
(10) Pub. No.: US 2007/0003043 A1
(43) Pub. Date: Jan. 4, 2007

(54) Method and system for content selection while call is on hold

(75) Inventor: Sandeep Kapur, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/165,750

(22) Filed: Jun. 23, 2005

(51) Int. Cl. H04M 3/42

(52) U.S. Cl. 379/211.02

(57) ABSTRACT

A method and apparatus for selecting the content to be played by a first party while a call is on hold is provided. The method includes establishing the call between the first party and a second party. The call can be placed on hold by the second party. While the call is on hold, the first party is free to select and play the content chosen by a user at the first party. The second party can re-establish the call, after which the content being played is stopped and the call continues.

### BACKGROUND OF THE INVENTION

1. Field of Invention

Embodiments of the invention relate in general to telephony systems. More specifically, the embodiments of the invention relate to methods and systems for selecting content to be played during the time a call is on hold.

2. Description of the Background Art

Telephony systems enable communication of information in a network. The end of the network that initiates communication can be known as the calling end. The end that is requested for communication by the calling end can be known as the called end. It may happen that the called end is busy after communication between the two ends has been initiated. In this case, the called end has the option of temporarily disconnecting its communication with the calling end. The process of temporarily disconnecting the communication is commonly known as ‘putting the call on hold’. While the call is on hold, the calling end waits for the called end to re-establish the communication. Communication is re-established when the called end resumes the call.

According to a conventional technique, the called end sends pre-selected information to the calling end while the call is on hold. The pre-selected information could be a recording that plays a message or music. In this case, the content to be played while the call is on hold is decided by the called end. However, the calling end cannot decide the content to be played while the call is on hold. This may result in the calling end being dissatisfied, especially if the hold is of a long duration. For example, customers who call callcenters are displeased when they are made to hold the call for a long time. This technique also results in poor utilization of network bandwidth, since the calling end and the called end use the network bandwidth, even when the call is on hold, to play the pre-selected information.

### BRIEF DESCRIPTION OF THE DRAWINGS

FIG. 1 illustrates a network environment wherein an exemplary embodiment of the present invention can be practiced.

FIG. 2 illustrates a call manager, in accordance with an exemplary embodiment of the present invention.

FIG. 3 is a flowchart depicting the requisite steps taken for managing communication in a call, in accordance with an exemplary embodiment of the present invention.

FIG. 4 is a flowchart depicting the requisite steps taken for managing communication in a call, in accordance with another exemplary embodiment of the present invention.

### DETAILED DESCRIPTION OF EMBODIMENTS OF THE INVENTION

The embodiments of the invention provide a method, a system, and a computer readable medium for selecting content while a call is on hold. The various embodiments of the invention provide a method that enables a first party (e.g., a calling party) to select the content to be played while the call is on hold. The method comprises establishing the call between the first party and a second party (e.g., the called party). Thereafter, the called end places the call on hold. On receiving information that the call has been placed on hold, the first party selects the content to be played while the call is on hold. The played content is stopped as soon as the second party removes the call from hold and re-establishes the communication. For the purpose of illustration, the first party is referred as a calling end and the second party is referred as a called end. However the invention is valid for reverse case also.

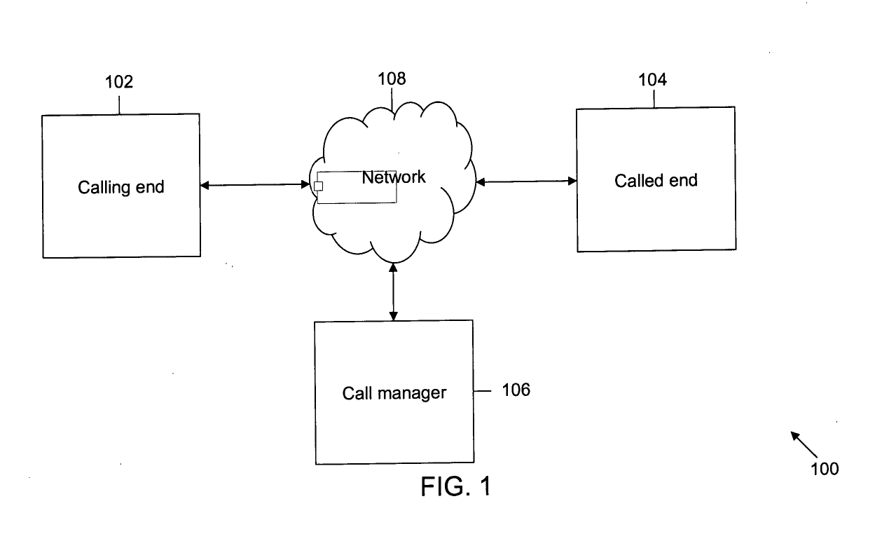

FIG. 1 illustrates a network environment 100 wherein an exemplary embodiment of the present invention can be practiced. Network environment 100 includes a calling end 102, a called end 104, and a call manager 106, connected to each other through a network 108. The user at calling end 102 initiates a request for the call to communicate with the user at called end 104. In various embodiments of the invention, calling end 102 and called end 104 are communication devices. Examples of communication device include, but are not limited to, a fixed-line telephone, a wireless telephone, an Analog Telephone (AT), an Internet Protocol (IP) phone, or any other communication device that is capable of handling multimedia signals. In one embodiment, an IP phone can be a Cisco IP Communicator, a Cisco SIP IP Phone 7960 Software, and so forth.

Called end 104 accepts the request for the call to establish communication in the call. Once the call is established between calling end 102 and called end 104, then these two communication devices can exchange data over network 108. Examples of networks include, but are not limited to, wired telephone network, wireless communication network, an Internet, a Local Area Network (LAN), a Wide Area Network (WAN), a Metropolitan Area Network (MAN), and a Virtual Private Network (VPN). In one embodiment, a physical cable makes the connections in network environment 100. In another embodiment, the connection can be a wireless one.

Furthermore, according to the various embodiments of the invention, the exchange of data between the two communication devices can be a voice data, a multimedia data, or a combination of both. While the call is in progress, called end 104 may place it on hold. Placing the call on hold implies that it is temporarily disconnected till called end 104 indicates a desire to re-establish it. In one embodiment, call manager 106 receives a call hold request from called end 104. Call manager 106 puts the communication in the call on hold by accepting the call hold request. Similarly, call manager 106 re-establishes the communication in the call when it receives a request to re-establish the call. The request can be sent by called end 104.

While the call is on hold, calling end 102 is allowed to play any content that is selected by the user at calling end 102. In an embodiment of the invention, call manager 106 can be placed at the site of called end 104. In this case, call manager 106 may reside in called end 104, communicating with calling end 102 over network 108.

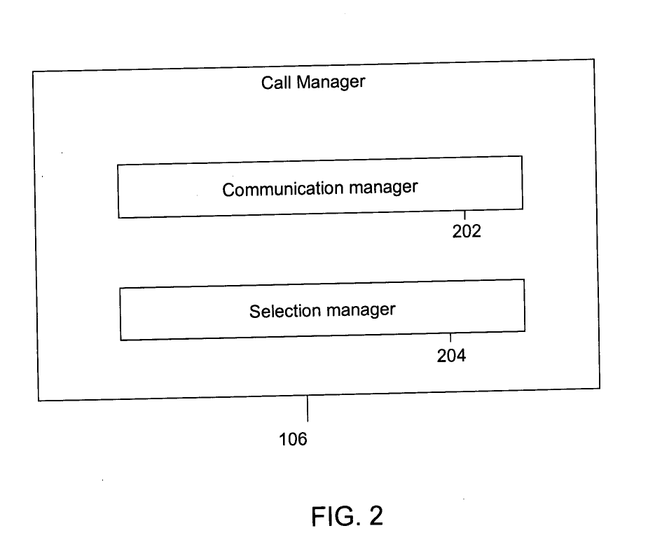

FIG. 2 illustrates a call manager 106, in accordance with an exemplary embodiment of the present invention. According to various embodiments of the invention, call manager 106 includes a communication manager 202 and a selection manager 204. Is is to be understood that the call manager 106 of FIG. 2 is merely an exemplary embodiment, and that a selection manage (e.g., software residing on a phone, etc.) may be enployed independent of, or in combination with, the call manager 106. The singalling function may also go through the call manager 106.

According to various embodiments of the invention, communication manager 202 manages communication during the call between calling end 102 and called end 104. When communication manager 202 receives the request for holding the call from called end 104, it places the communication in the call on hold. While the call is on hold, communication manager 202 ensures that transfer of data is temporarily suspended between calling end 102 and called end 104. Therefore, during this time, calling end 102 is free to select and play any content that it chooses.

In an embodiment of the invention, selection manager 204 enables calling end 102 to select the content to be played while the call is on hold. Examples of the selected content can include, but are not limited to, a video file, an audio file, a text file, and an image file. The type of content selected by calling end 102 is limited by the applications supported by the communication device used by the user at calling end 102. For example, calling end 102 may be a mobile device that supports multimedia content. In this case, calling end 102 may be able to view, hear and download the multimedia content. Information on the multimedia contents available in a collection can be provided by selection manager 204. An example of a collection of multimedia information can be a collection of websites on the Internet, which offers music for streaming or downloading, news clips, and so forth. Once calling end 102 selects the content from the available options, the selected content is played.

In an embodiment, communication manager 202 receives the call re-establish request from called end 104. Communication manager 106 re-establishes the communication in the call by accepting the request. In an embodiment, the information relating to the action taken by called end 104, to remove the call from hold, leads to the termination of the content being played while the call was on hold. Thereby, the call is re-established between calling end 102 and called end 104. According to various embodiments, call manager 106 is also capable of managing various other requests that can be sent by the calling end 102 or called end 104.

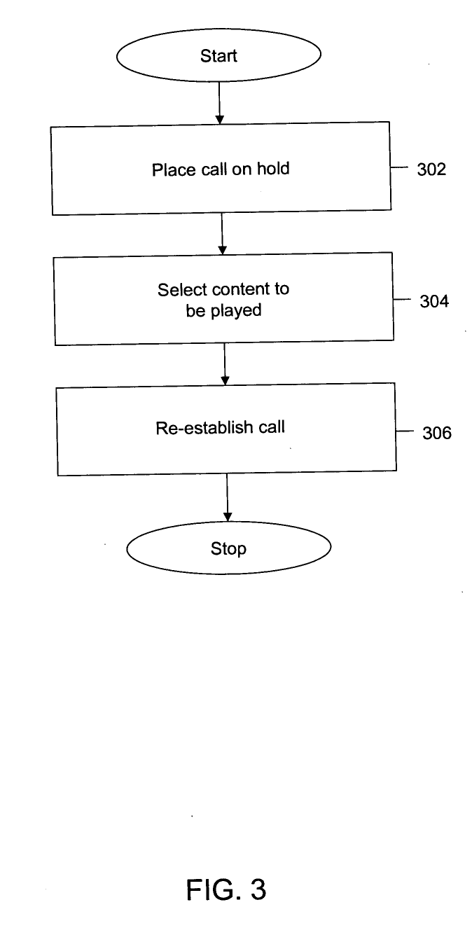

FIG. 3 is a flowchart depicting the requisite steps taken for managing communication in a call, in accordance with an exemplary embodiment of the present invention. At step 302, the call is placed on hold. Call manager 106 receives the call hold request from called end 104. Call manager 106 accepts the request and places the communication in the call on hold. In one embodiment, communication manager 202 accepts the call hold request from called end 104 and places the communication in the call on hold. Once the communication in the call is on hold, calling end 102 can select the content while the call is on hold.

At step 304, call manager 106 enables calling end 102 to select the content to be played while the call is on hold. According to various embodiments, selection manager 204 at call manager 106 enables calling end 102 to select the desired content. Thus, calling end 102 can select the content to be played while the call is placed on hold. The content can include multimedia data. In another embodiment, selection manager 204 can provide information pertaining to the multimedia data that is available for selection. Further, at step 306, call manager 106 receives the call re-establish request from called end 104. Call manager 106 accepts the call re-establish request and re-establishes the communication in the call. Once the call is re-established the content being played is stopped.

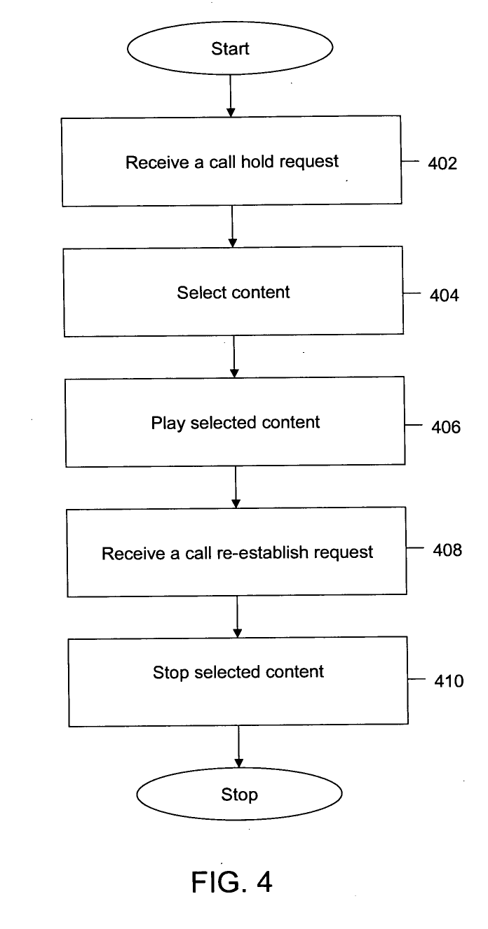

FIG. 4 is a flowchart 400 depicting the requisite steps for telephonic communication, in accordance with another exemplary embodiment of the present invention. At step 402, calling end 102 receives the call hold request from called end 104. In one embodiment, called end 104 sends digital data in the form of packets that include the call hold request to place the call on hold. In an alternate embodiment, the data can be an analog data. In various embodiments, the digital or the analog data can be voice data, multimedia data, or a combination of both. In one embodiment, calling end 102 sends a digital data using Voice-over-Internet Protocol (VoIP). Further, VoIP uses a transport protocol for transmission of data packets. Examples of transport protocol include, but are not limited to, a Real-time Transport Protocol (RTP), a Transmission Control Protocol (TCP), a User Datagram Protocol (UDP), and a Stream Control Transmission Protocol (SCTP). According to various embodiments of the invention, RTP is used for communication. In an embodiment, RTP uses Session Initiation Protocol (SIP) to initiate a session for the call. SIP is a protocol that creates, modifies and terminates call sessions.

At step 404, calling end 102 selects a content to be played in the duration for which the call is on hold. In an exemplary embodiment, calling end 102 first accepts the call hold request and places the communication in the call on hold. The call hold request includes a set of hold description parameters to which calling end 102 and called end 104 agree, so that the call is placed on hold. In one embodiment, the set of hold description parameters can be a set of hold Session Description Protocol (SDP) parameters. In alternate embodiments, the SDP parameters can be sent through various transmission protocols such as a Session Announcement Protocol (SAP), a Real-time Streaming Protocol (RTSP), a Hyper Text Transport Protocol (HTTP), an electronic mail using Multipurpose Internet Mail Extensions (MIME) extensions, and so forth. Further, the content of the call hold request can include a destination address of called end 104. In one embodiment, the destination address can be the SIP address of called end 104. In an alternate embodiment, the specific destination address can be an Internet protocol (IP) address. In one embodiment, the set of hold-description parameters can be a set of hold SDP parameters. The set of hold SDP parameters describe the content of a hold request message. The content of the hold request message can include an SIP event HOLD that is used to place the call on hold. Moreover, this set of hold SDP parameters includes the SIP address of calling end 102. Calling end 102 agrees with the set of hold SDP parameters and places the call on hold. When the call is on hold, calling end 102 takes control of the content to be played while the call is on hold. Thus, at step 404, calling end 102 can select the content to be played while the call is on hold. According to various embodiments, selection manager 204 enables calling end 102 to select the desired content. At step 406, called end 102 plays the content selected at step 404. As mentioned earlier, the content played could include an audio data, multimedia data, or any other data that called end 102 is capable of playing. At step 408, calling end 102 receives the call re-establish request from called end 104 to re-establish communication and to remove the call from hold. According to various embodiments, communication manager 202 enables the process of re-establishing the communication in the call. In one embodiment, calling end 102 receives the digital data in the form of packets that include the request to re-establish the communication. This request can use SIP and may include a set of re-establish description parameters to which calling end 102 can agree to re-establish the call with calling end 102. At step 410, calling end 102 accepts the call re-establish request from the called end 104. In one embodiment, the set of re-establish description parameters that calling end 102 accepts can be a set of re-establish SDP parameters that describe the content of a re-establish request message. The content of the re-establish request message can include an SIP event RE-ESTABLISH that is used to re-establish the communication. This set of re-establish SDP parameters also includes the SIP address of calling end 102. Calling end 102 then agrees with the set of re-establish SDP parameters to re-establish the call. Thereafter, the communication is re-established and the content being played is stopped.

In an alternative embodiment of the invention, calling end 102 can place the communication on hold. In this case, called end 104 selects the content to be played while the call is on hold. Details pertaining to the method for selecting the content while the call is on hold have been explained earlier in conjunction with the method of the invention

Embodiments of the present invention have the advantage that the user at the calling end can select the content of its choice that will be played while the call is on hold. The user's time, while the call is on hold, is utilized in a productive manner, since the selected content has been chosen by the user. This also saves network bandwidth, since the calling user can play the selected content while the call is placed on hold. The various embodiments of the invention can be useful in call center applications where calls can be put on hold for long periods of time. Further, the called user does not need to play any content while the call is on hold, which saves toll charges for the called user. Moreover, the various embodiments of the invention provide a real-time stream, which is established when the call between the calling user and the called user is re-established.

Although the invention has been discussed with respect to specific embodiments thereof, these embodiments are merely illustrative, and not restrictive, of the invention.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for managing communication during a call, the call being established by a first party with a second party, the method comprising
placing the call on hold;
enabling the first party to select a content while the call is on hold; and
re-establishing the call when the call is removed from hold.

2. The method of claim 1, wherein the placing the call on hold comprises receiving a call hold request from the second party, the request being received by the first party.

3. The method of claim 1, wherein the enabling the first party to select the content further comprises
selecting the content, the content being selected by the first party;
playing the selected content; and
stopping the selected content when the call is re-established.

4. The method of claim 1, wherein the re-establishing the call comprises receiving a call re-establish request from the second party, the request being received by the first party.

5. A method for managing communication during a call, the call being established with a second party, the method comprising
receiving a request for placing the call on hold, the request being made by the second party;
selecting a content while the call is on hold;
playing the selected content;
receiving a request for re-establishing the call, the request being made by the second party; and
stopping the selected content to re-establish the call.

6. A system for managing communication during a call, the call being established by a first party with a second party, the system comprising
means for placing the call on hold;
means for enabling the first party to select a content while the call is on hold; and
means for re-establishing the call when the call is removed from hold.

7. A system for managing communication during a call, the call being established by a first party, the system comprising
a communication manager for managing requests for placing the call on hold and re-establishing the call; and
a selection manager for enabling the first party to select a content while the call is on hold.

8. An apparatus for managing communication during a call, the call being established by a first party with a second party, the apparatus comprising
a processing system including a processor coupled to a display and user input device;
a machine-readable medium including instructions executable by the processor comprising
one or more instructions for placing the call on hold;
one or more instructions for enabling the first party to select a content while the call is on hold; and
one or more instructions for re-establishing the call when the call is removed from hold.
